(19) United States
(12) Patent Application Publication
(10) Pub. No.: US 2012/0097762 A1
(43) Pub. Date: Apr. 26, 2012

(54) PAINT SPRAY GUN

(75) Inventors: Ralf Gehrung, Stuttgart (DE); Rocco Di Nicola, Leonberg (DE); Peter Dettlaff, Remseck (DE)

(73) Assignee: Sata GmbH & Co. KG, Komwestheim (DE)

(21) Appl. No.: 13/380,949

(22) PCT Filed: Jun. 7, 2010
(86) PCT No.: PCT/EP2010/003399

§ 371 Date: Dec. 27, 2011

(30) Foreign Application Priority Data
Jul. 8, 2009 (DE) 10 2009 032 399.6

(51) Int. Cl. B05B 1/28

(52) U.S. Cl. 239/291

(57) ABSTRACT

The invention relates to a paint spray gun (1) having a compressed air distribution chamber (8) into which a compressed air feed line (10), a round jet line (6) and a wide jet line (7) open, the quantity of compressed air supplied to the compressed air distribution chamber (8), the round jet line (6) and the wide jet line (7) being adjustable via a setting element arranged in the compressed air distribution chamber (8) and rotatable from outside by an actuating element (15) about an axis of rotation (D) extending through the compressed air distribution chamber (8). Said paint spray gun (1) is characterized in that the setting element is formed as a rotary distributor (14) that is held immovably in the axial direction of the axis of rotation (D) and can be rotated about the axis of rotation (D) in order to open and close openings (6′, 7′, 10′) of the round jet line (6) and/or the wide jet line (7) and/or the compressed air feed line (10).

The invention relates to a paint spray gun according to the preamble of Claim 1 and an associated compressed air distribution insert according to the preamble of Claim 18.

The generic paint spray gun is known from EP 0 706 832 B1. Said paint spray gun presents a compressed air distributor which is connected to a compressed air feed line, and which distributes the compressed air of the compressed air feed line over a horn air supply line and a round jet supply line. The compressed air quantity fed to the horn air supply line can be set by screw adjustment of a plug, which presents a terminal sealing spigot for continuous opening or closing of the horn air supply line. To delimit the pressure that is generated in the round jet area to a maximum, if at the time of the closing of the horn air the pressure in the round jet area increases above the maximum admissible for paint spray guns, the plug presents, seen from its end, an area of larger diameter, in the direction towards the sealing spigot, which also continuously narrows the air pathway between the compressed air feed line and round jet supply line, at the time of the closing of the horn air supply line. The plug is shifted there by means of a knurled knob rotating in the axial direction. The solution described therein presents the disadvantage that, owing to the axial resetting kinematics of the plug for opening or closing the lines in the compressed air distributor, the knurled knob needs to be turned one rotation. Moreover, the design of the plug with the sealing spigots and the plate-like disk makes it impossible to determine or calculate with precision the distribution of air in the compressed air distributor. In addition, the multipart design is disadvantageous here from the point of view of manufacturing technology. Moreover, during the adjustment, the distance between the knurled knob and the gun body changes, which is often perceived as disadvantageous.

The invention is consequently based on the problem of providing a paint spray gun and a compressed air distributor that overcome the above-mentioned disadvantages, and that allow a setting of the pressure, which is simple to perform, as well as an easily calculated compressed air distribution in the paint spray gun.

This problem is solved by a paint spray gun having the characteristics of Claim 1, as well as by a compressed air distribution insert having the characteristics of Claim 18. Advantageous embodiments and preferred embodiments of the invention can be taken from the dependent claims.

A paint spray gun mentioned in the introduction is characterized according to the invention by the fact that the setting element is designed as a rotary distributor for opening and closing the openings of the round jet line and the wide jet line, which is immovable in the axial direction of the axis of rotation in the rotary distributor, which is held in the compressed-air distribution chamber, and which can be rotated about the axis of rotation. Due to this exclusive adjustment kinematics of the rotary distributor, the clearly smaller adjustment angle from completely closed to completely wide jet opening kinematics is made possible here. In the solution according to EP 0 706 832 B1, the adjustment angle, on the other hand, is approximately 410°; in this case, the knurling knob therefore has to be turned from the opened to the closed horn air opening by more than one full rotation. This prevents, among other factors, a simple display of the current opening position indicator of the horn air opening. Moreover, the design of the rotary distributor, and thus the setting of the correct ratio of the different openings in the compressed air distribution chamber relative to each other can be simulated, calculated, or determined empirically, in a simple way. An additional advantage is that the handle for the rotary distributor is always at the same distance from the paint spray gun.

In a preferred embodiment of the invention, the compressed air distribution chamber is designed as a compressed air distribution cylinder having an opening, and walls formed by the bottom and a lateral surface, wherein the rotary distributor presents, at its end turned away from and/or facing the rotary handle, a guide that is applied to the lateral surface. As a result, a simple design can be achieved that at the same time provides good guidance of the rotary distributor in the compressed air distribution cylinder. In a manner that is advantageous for the manufacturing technology, the guide can be a circular disk and/or a circular ring having an outer diameter adapted to the inner diameter of the compressed air distribution cylinder.

It is preferred to form the rotary distributor so that it passes by a lateral surface section of a cylinder about the axis of rotation, which rotary distributor slides with rotation and, conclusively, along the lateral surfaces of the compressed air distribution cylinder.

The round jet opening, the wide jet opening, and/or the compressed air feed line opening can preferably open into the lateral surface of the compressed air distribution cylinder, and the round jet setting area, the wide jet setting area, or the compressed air feed line setting area can be rotated along the lateral surface of the compressed air distribution cylinder. Alternatively or additionally, the round jet opening, the wide jet opening, and/or the compressed air feed line opening can also open in the bottom of the compressed air distribution cylinder, wherein the respective setting area can then be provided.

In order to enable a simple display of the rotary distributor setting in the compressed air distribution chamber, a setting display can be provided on the rotary handle for displaying the setting of the rotary distributor in the compressed air distribution chamber.

A compressed air distribution insert mentioned in the introduction is characterized according to the invention by the fact that, on an end of the distribution spindle, which can be inserted into the compressed air distribution chamber, a rotary distributor can be provided, which is not movable with respect to the rotary handle in the axial direction of the axis of rotation, and which is rotatable about the axis of rotation.

Additional features and advantages of the invention result from the following description of a preferred embodiment example in reference to the accompanying drawings. The drawings show:

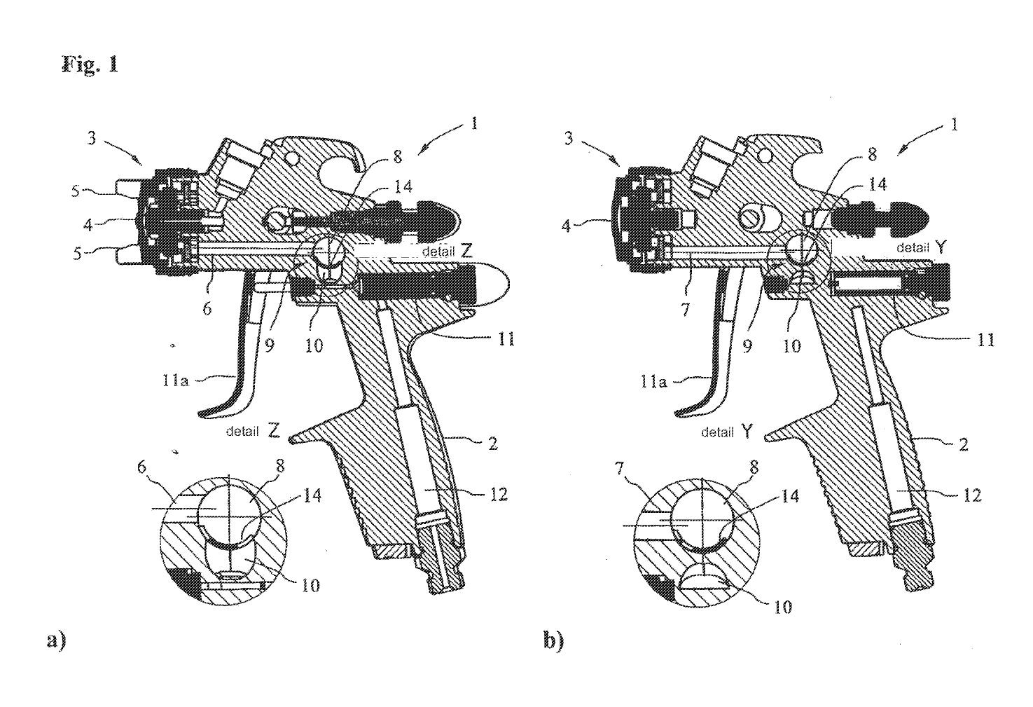

FIG. 1, two cross-sectional views through a paint spray gun according to the invention with completely opened round and wide jet lines along a

a) round jet line with detail Z;

b) wide jet line with detail Y;

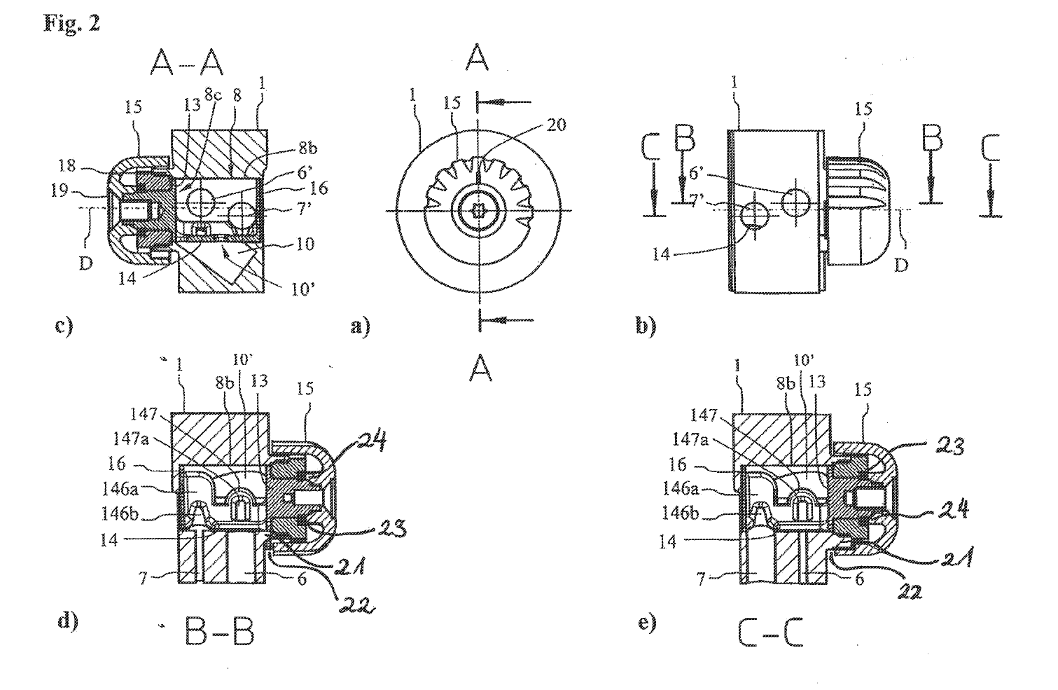

FIG. 2, several views of a compressed air distributor with completely opened round and wide jet lines, namely

a) a front top view on the knurled knob of the compressed air distributor;

b) a side top view of the compressed air distributor of FIG. 2a from the left;

c) a section through the compressed air distributor of FIG. 2a along the line A-A;

d) a section through the compressed air distributor of FIG. 2b along the line B-B;

e) a section through the compressed air distributor of FIG. 2b along the line C-C;

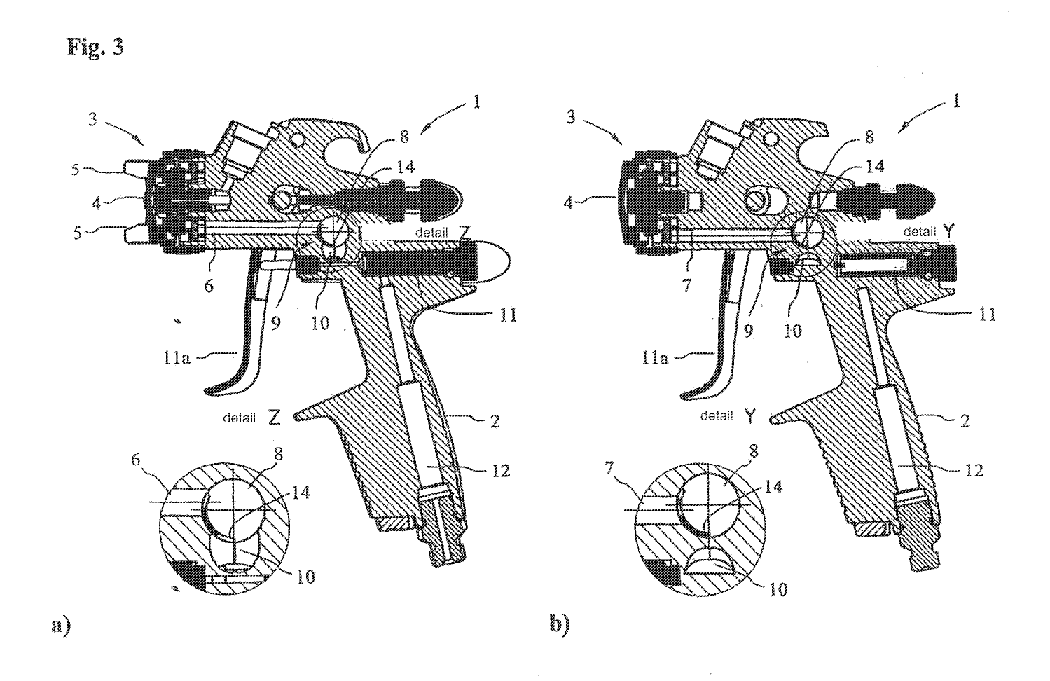

FIG. 3, two cross-sectional views similar to FIG. 1 with partially opened round and wide jet lines;

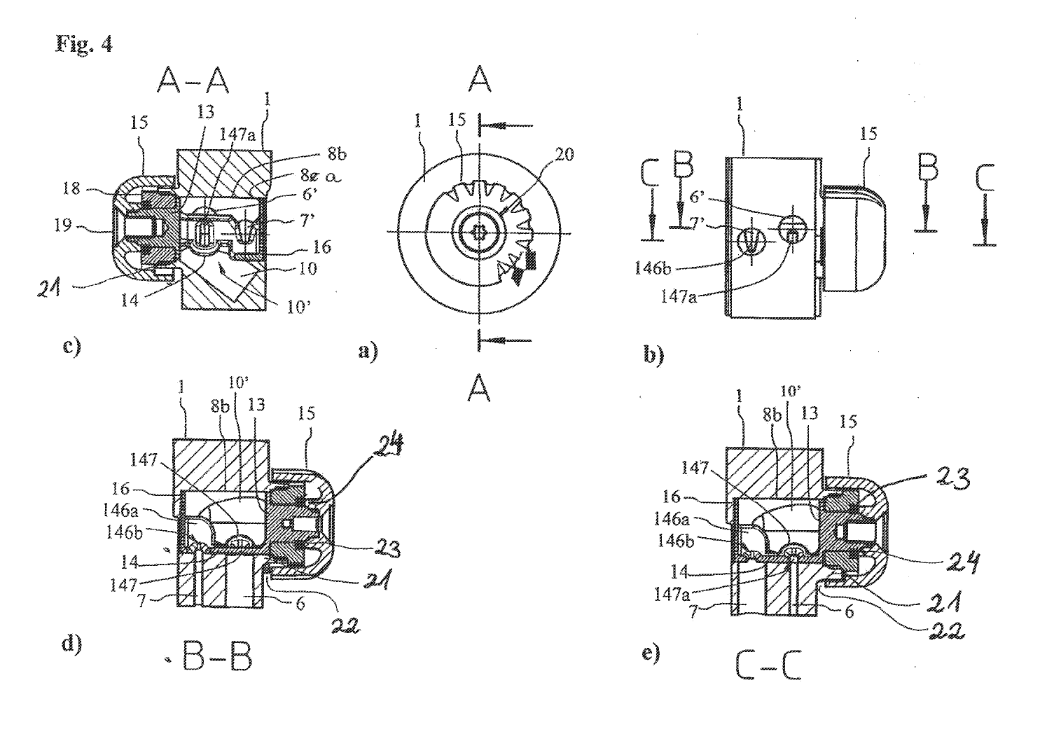

FIG. 4, the views of FIG. 2 with partially opened round and wide jet lines;

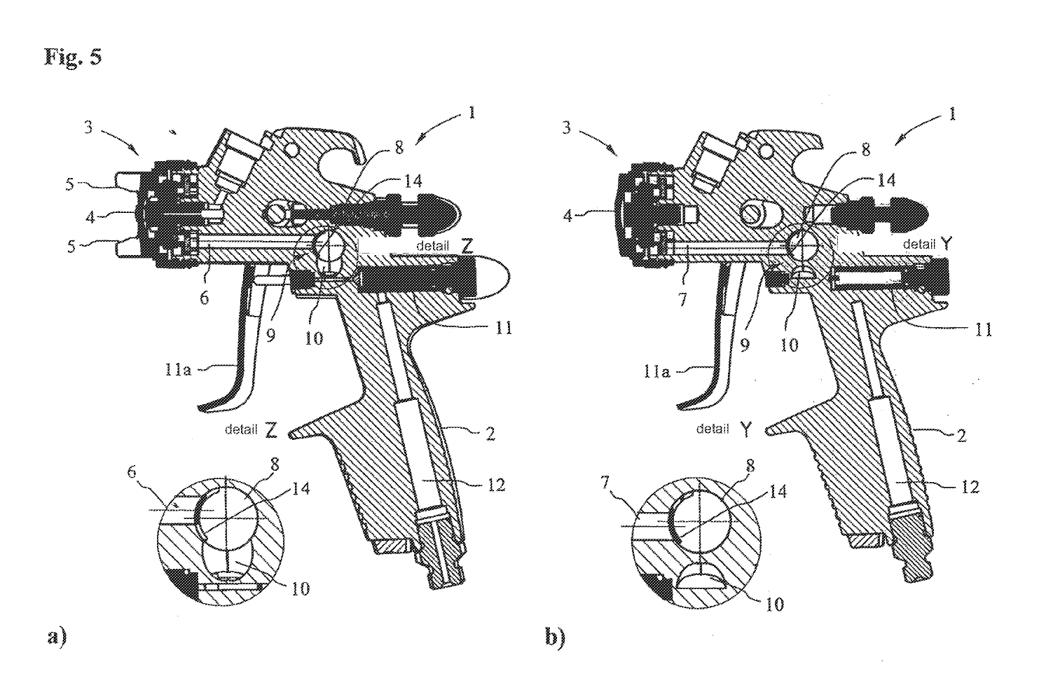

FIG. 5, two cross-sectional views similar to FIG. 1 with completely closed round and wide jet lines;

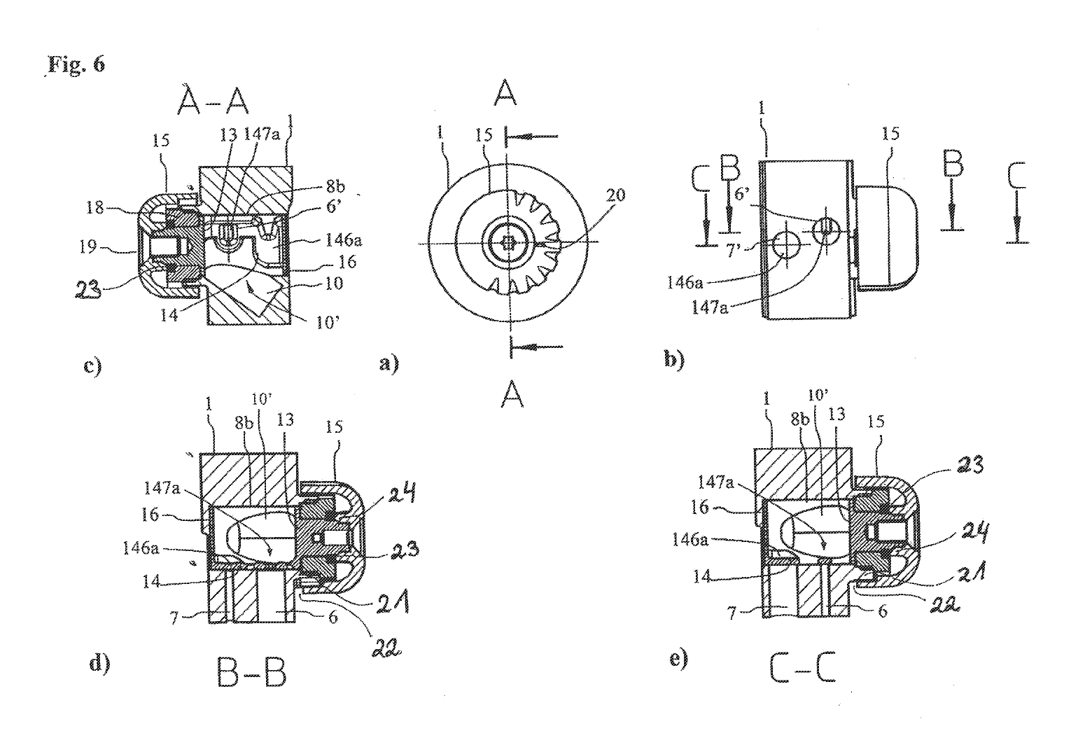

FIG. 6, the views of FIG. 2 with completely closed round and wide jet lines;

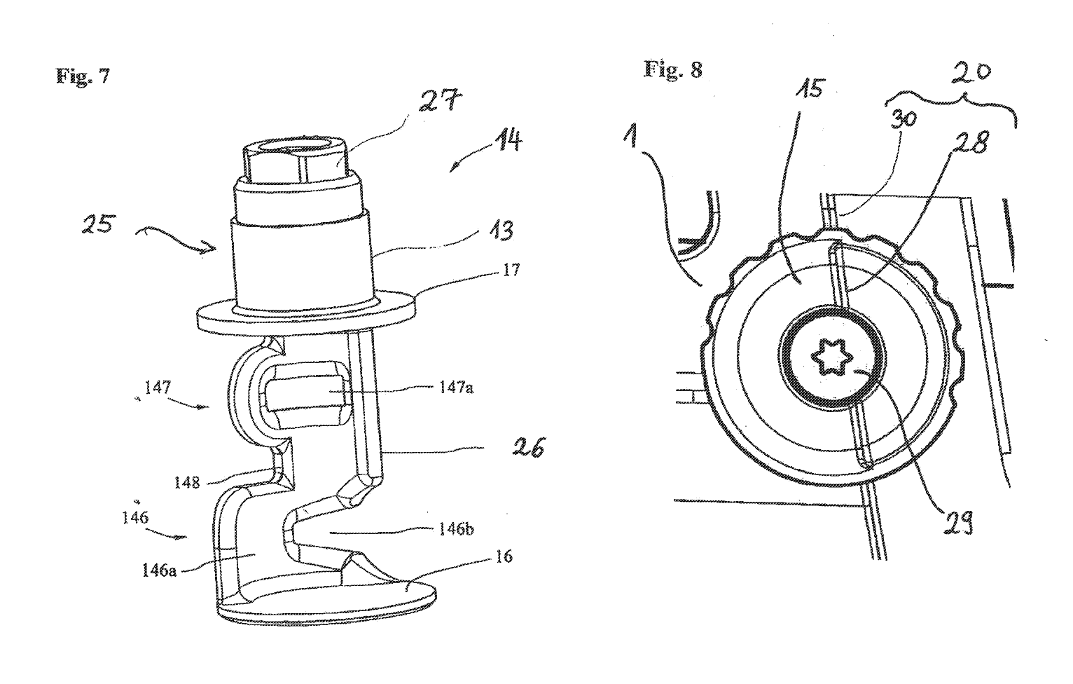

FIG. 7, a diagrammatic three-dimensional view of a compressed air distribution spindle, and

FIG. 8, a frontal top view on another knurled knob of the compressed air distributor.

FIG. 1a shows a section through a paint spray gun 1 with a handle 2 and a paint nozzle head 3. The paint nozzle head 3 presents a central round jet nozzle 4 as well as two wide jet nozzles 5 arranged on horns. The round jet nozzle 4 is supplied via a round jet line 6 shown in FIG. 1a with compressed air, while the wide jet nozzles 5 are supplied with compressed air via a wide jet line 7 shown in FIG. 1b. This design of the paint spray gun 1 itself is known. The round jet line 6, as well as the wide jet line 7, open at their ends turned away from the paint nozzle head 3, with a round jet line opening 6′ or wide jet line opening 7′, into a compressed air distribution chamber—designed as a compressed air distribution cylinder 8—of a compressed air distributor 9.

The compressed air distribution cylinder 8 is exposed to compressed air via a compressed air feed line opening 10′ of a compressed air feed line 10 and via a valve device 11, which in itself is known, from the compressed air feed 12. The valve device 11 is operated in a known manner by means of a drain-off 11a, so that, via the compressed air feed 12, from a not-shown compressed air source, for example, a compressor, compressed air can be introduced into the compressed air distribution cylinder 8.

In FIG. 1a, the section extends through the paint spray gun through the round jet line 6, while in FIG. 1b it extends through the wide jet line 7. As shown particularly in the detail Z or Y, the round jet line 6 is located, from the point of view of the observer of FIG. 1, before and in the paint spray gun 1 above the wide jet line 7.

The paint spray gun 1 according to the invention differs from the usual paint spray guns primarily by the compressed air distributor 9 according to the invention, which is described in detail in reference to FIGS. 2 and 7. FIG. 2a shows a top view on the pressure distributor 9 of FIG. 1. FIG. 2b shows a side view of a detail of the paint spray gun on the left of FIG. 2a, with easily recognizable round jet line 6 and wide jet line 7. FIG. 2c shows a section along the line A-A in FIG. 2a, FIG. 2d a section along the line B-B in FIG. 2b, and FIG. 2e a section along line C-C in FIG. 2b.

In order to be able to set the compressed air distribution in the compressed air distribution cylinder 8, as well as the pressure in the round jet line 6 and wide jet line 7, a radially adjustable distribution spindle 13 with a rotary distributor 14, as shown in FIG. 7, is inserted into the compressed air distribution cylinder 8.

The distribution spindle 13 and thus the rotary distributor 14 can be turned by means of a rotary handle designed as a knurled knob 15, which functions as handle, radially about the axis of rotation D in the compressed air distribution cylinder 8. The knurled knob 15 can be turned clockwise from the position shown in FIG. 2a with open wide jet line opening 7′, through the position, shown in FIG. 4a, with partially open wide jet line opening 7′, into the position, shown in FIG. 6a, with closed wide jet line opening 7′. As a result, the supply of compressed air to the wide jet nozzles 5 is decreased gradually at the horns of the paint nozzle head 3 until the pressure is off. A turning of the knurled knob 15 clockwise beyond the position shown in FIG. 6a, or counterclockwise beyond the position shown in FIG. 2a, is prevented by abutments 21, which in the present embodiment example are formed integrally with the spray gun body 1 (see FIGS. 2d, 4d, 6d as well as 2e, 4e and 6e). As a result, one ensures that, particularly in the completely closed wide jet line opening 7′ shown in FIG. 6a, compressed air is not again led into the wide jet line 7 due to accidental continuation of the clockwise turning, and the minimum quantity or reduced air quantity in the round jet line 6 is not increased or not further decreased.

The knurled knob 15 is here always at the same distance 22 from the piston body 1. The distance is selected in such a manner that a penetration of overspray or the like to the distribution spindle 13 cannot occur. In the embodiment example, it is approximately 1.2 mm. The design according to the invention thus has a high operational reliability. In addition, possible irritation due to a handle being in a high position are avoided.

In FIG. 2c, the range of the paint spray gun 1 can be seen, in which the compressed air distribution cylinder 8 is introduced in the form of a cylindrical bore. The bottom 8a of the bore is planar, and forms an angle of roughly 90° with the lateral surface 8b of the compressed air distribution cylinder 8. Bottom 8a and lateral surface 8b form the walls of the compressed air distribution cylinder 8. From below, in reference to FIG. 2c, the bore of the compressed air feed line 10 can be seen, while the round jet line 6 and the wide jet line 7 open into the compressed air distribution cylinder 8, offset by roughly 90° in the peripheral direction of the compressed air distribution cylinder 8 towards the compressed feed line 10. The rotary distributor 14 can be inserted from an opening 8c of the compressed air distribution cylinder 8 into the latter.

The rotary distributor 14 presents, at its lower end in FIG. 7 and at the right end in FIG. 2c, a circular bottom disk 16. On the opposite end of the rotary distributor 14, the distribution spindle 13 presents a circular cover plate 17 which largely seals the inner space of the compressed air distribution cylinder 8 with respect to the exterior. Both the bottom disk 16 and also the cover plate 17 serve as a swivel guide of the rotary distributor 14 in the compressed air distribution cylinder 8, and ensure an application by pressure of the rotary distributor 14 on the lateral inner surface of the compressed air distribution cylinder 8. For this purpose, the bottom disk 16, as well as the cover plate 17, are adapted to the inner diameter of the compressed air distribution cylinder 8 in a manner such that an exact centric rotation is possible without large clearance, and simultaneously a good application by pressure of the rotary distributor 14 on the lateral inner surface is ensured, in order to enable a defined covering of the round jet line opening 6′, the wide jet line opening 7′, and the compressed air feed line opening 10′.

In the present embodiment example, the rotary distributor 14 is designed in two parts. In its area 25, shown at the top in FIG. 7, which area extends from the threading 27 to the cover plate 17 inclusive, the rotary distributor 14 is made of metal, namely brass. As a result, particularly high material strength and also precise guidance is ensured. The lower area 26, on the other hand, which extends to the bottom disk 16 inclusive, is made of plastic, namely polyamide. It is manufactured so that it is very slightly larger in terms of width, so that it is slightly squeezed after insertion into the spray gun 1. This ensures an excellent sealing guidance. In addition, in spite of the relatively complicated construction, due to the indicated material selection, it can be manufactured without problem by injection molding. Because of the combination of materials selected, the manufacturing costs of the rotary distributor 14 can consequently be kept within the desired limits.

Naturally, manufacturing the rotary distributor 14, as a single part or as several parts, from any other material or any other plastic or any other desired material combination is also possible.

At its top end, the distribution spindle 13 is rotatably mounted by means of a threaded sleeve 18 in the compressed air distribution cylinder 8, so that the rotary distributor 14, although being rotatable in the compressed air distribution cylinder 8 about the axis of rotation D, is not shiftable in the axial direction of the axis of rotation D in the compressed air distribution cylinder 8. The threaded sleeve 18 for this purpose is screwed by means of an outer threading into a corresponding inner threading at the outer end of the compressed air distribution cylinder 8. The circular area of the cover plate 17, which is turned away from the rotary distributor 14, serves as an abutment for a front side of the threaded sleeve 18, which faces the compressed air distribution cylinder 8. The threaded sleeve 18 thus ensures a secure seat of the distribution spindle 13, and consequently of the rotary distributor in the compressed air distribution cylinder 8, and, in collaboration with a gasket seal 23 having an annular design here, in addition to the cover plate 17, it seals the inner space of the compressed air distribution cylinder 8 against air flowing outwards.

In addition, the threaded sleeve 18 is sealed with respect to the gun body 1.

The knurled knob 15 is rotatably connected via a threaded screw 19 shown in FIG. 2c to the distribution spindle 13. The threaded screw 19 for this purpose engages in the head end of the rotary distributor 14, which is provided with a threading 27. Through the inner collar 24 on the knurled knob 15, the gasket seal 23 is prestressed at the time of the tightening of the threaded screw 19 in order to achieve a reliable seal.

The inner collar 24 on the knurled knob 15 works in collaboration with the abutments 21 on the piston body 1. In the present embodiment example, in each case one abutment 21 is provided on the opening position, as well as on the closed position. In the present embodiment example, the two positions enclose an angle of 95°. As a result, the adjustment can be visually perceived very well.

In other conceivable embodiments, larger angles, for example, 90°-180°, but preferably always smaller than 360°, can be provided.

As can be seen in FIG. 2a, the knurled knob 15 presents a setting display 20 in the form of a notch which points perpendicularly upwards in the case of the completely open wide jet line opening 7′ shown in FIG. 2, while, in the case of completely closed wide jet line opening 7′, the setting display 20 is rotated by approximately 95° clockwise in the position shown in FIG. 6a.

Alternatively, instead of the notch, an imprinted single marking or a scale, for example, can be provided as setting display 20. Obviously, the setting display 20 could be provided on the gun body 1 instead of the knurled knob 15.

In the variant of the knurled knob 15 shown in FIG. 8, the setting display 20 is designed in a raised position-marking 28 formed on the knurled knob 15. The position-marking 28 in this embodiment example is designed to be particularly long, and it extends to the side of the imaginary diameter line over the entire surface of the knurled knob 15, with the exception of the middle area 29 of the latter. On the gun body 1, a raised position marking 30, adjusted to the position marking 28, is provided. In this variant, the adjustment can be perceived visually particularly well.

The construction of the distribution spindle 13 and of the rotary distributor 14 is now explained in reference to FIG. 7. Due to the opening of the wide jet opening 7 in the lower bottom area of the compressed air distribution cylinder 8, a wide jet setting area 146 of the rotary distributor 14 is arranged adjacent to the bottom disk 16. The wide jet setting area 146 presents a wide jet closing area 146a for the complete closing of the round jet line opening 7′ as well as a wide jet opening area 146b for the successive release or closing of the wide jet line opening 7′.

In contrast to the above, a round jet setting area 147 is located above the wide jet setting area 146 and in the vicinity of the cover plate 17, since the round jet line 6 opens into the upper area of the compressed air distribution cylinder 8. Since the round jet line opening 6′ is also slightly offset in the peripheral direction of the compressed air distribution cylinder 8 towards the wide jet line opening 7′, the wide jet setting area 147 is additionally offset accordingly in the peripheral direction with respect to the wide jet setting area 146. The wide jet setting area 147 presents an approximately rectangular round jet setting opening 147a, in the present embodiment example, which is offset with respect to the wide jet closing area 146a in such a manner that, when the wide jet line 7 is completely closed, and simultaneously the compressed air feed line 10 is completely opened, the permissible maximum pressure in the round jet line 6 and thus on the round jet nozzle 4 is not exceeded.

Obviously, the round jet setting area 147 can also be designed as an elongated hole or the like.

The left margin of the rotary distributor 14, in FIG. 7, the round jet setting opening 147a, and also the wide jet closing area 146a form a compressed air feed line setting area and are designed in such a manner that, in the position of the rotary distributor 14 shown in FIG. 6, the compressed air feed line opening 10′ is opened completely towards the compressed air distributor 8, and covered by none of the just-mentioned components of the rotary distributor 14.

In the state shown in FIG. 2, on the other hand, both the wide jet closing area 146a and also the round jet setting area 147, on the left in FIG. 7, as well as the short area 148 located between them, extend so far into the compressed air feed line opening 10′ that, when the round jet line opening 6′ and the wide jet line opening 7′ are completely open, the maximum pressure in the round jet line 6 or the wide jet line 7 does not exceed the maximum permissible pressure.

FIGS. 1 and 2 show the position of the rotary distributor 14 when the round jet line opening 6′ and wide jet line opening 7′ are completely open, i.e., maximum pressure on the round jet nozzle 4 and the wide jet nozzles 5. The rotary distributor 14 here completely opens the round jet line opening 6′ and wide jet line opening 7′ in the compressed distributor cylinder 8. The compressed air feed line opening 10′, on the other hand, is covered maximally by the compressed air feed line setting area of the rotary distributor 14, in order to limit the pressure in the compressed air distribution cylinder 8 to the maximum permissible pressure.

To reduce the feed of compressed air to the wide jet nozzle 5, and thus reduce the pressure on the wide jet line opening 7′ in the compressed air distribution cylinder 8, the knurled knob 15 is turned from the position shown in FIG. 2a clockwise by approximately 45° in the direction of the position shown in FIG. 4a. The user can see this immediately on the setting display 20. As a result, the wide jet opening area 146b of the wide jet setting area 146, which is shown in FIG. 7, is turned with its converging narrowing side flanks over the wide jet line opening 7′. At the same time, the round jet setting area 147 is turned over the round jet line opening 6′, which as a result is partially covered by the front edge of the round jet setting area 147, which is on the right in FIG. 7, and partially uncovered by the round jet setting opening 147a. At the same time, due to the turning of the rotary distributor 14, the compressed air feed line opening 10′ is successively uncovered, but, in the position shown in FIG. 4, it continues to be covered partially by the rotary distributor 14. Since the round jet line opening 6′ and wide jet line opening 7′ are reduced in terms of size simultaneously, while the inlet of compressed air through the compressed air feed line opening 10′ is made larger, the pressure ratios in the compressed air distributor 9 adjust themselves in such a manner that the permissible maximum pressure on and in the round jet line 6 and also the wide jet line 7 is not exceeded.

If the knurled knob 15 and thus the rotary distributor 14 is then turned by an additional approximately 45° clockwise from the position shown in FIG. 4a into the position shown in FIG. 6a, the position with completely closed wide jet line opening 7′ is reached. As one can see in FIGS. 6c and 6b, the wide jet line opening 7′ is then completely closed, while the round jet line opening 6′ is still exposed through a portion of the round jet setting opening 147a to compressed air from the now completely opened compressed air feed line opening 10′ (FIG. 6c to e). By means of the rotary distributor 14 and its special implementation, that is, the conically narrowing course of the wide jet opening area 146b, of the round jet opening area 147a, of the adjoining round jet setting area 147, and of the compressed air feed line setting area, it is ensured that, throughout the entire closing process of the wide jet line opening 7′, a pressure that exceeds the predetermined maximum pressure is not reached at or in the round jet opening 6, or at or in the wide jet line 7 and thus on the associated nozzles (round jet nozzle 4 and wide jet nozzles 5).

Alternatively, the round jet line opening 6′ could be completely closed, by selecting an appropriate geometric shape of the round jet setting opening 147a.

In addition, depending on the shape of the wide jet opening area 146b, either an exponential, or a linear, or a degressive closure characteristic can be achieved.

The fact that, in the embodiment of the rotary distributor 14 according to the invention, the opening 10′ of the compressed air feed line 10 can close, is the result of the above described constructive design of the rotary distributor 14, which is adapted congruently to the surfaces of the compressed air feed line 10. In alternative embodiments without such adaptation, the compressed air feed line 10 is accordingly not [closed] or not completely closed. There is no risk of large negative consequences for the desired function of the paint spray gun pistol. In any case, according to the invention, the possibility exists to feed the entire air quantity or reduced air quantity to the rotary distributor 14, as desired.

An essential advantage compared to the solutions known from the state of the art is that, in the present invention, the radial adjustment kinematics of the rotary distributor 14 allow a considerably smaller adjustment angle. In the solution according to EP 0 706 832 B1, the adjustment angle is, for example, approximately 410°, the knurled knob thus has to be turned there from the opened to the closed horn air opening, by more than one full rotation. This prevents, among other factors, a simple setting display of the current opening of the horn air opening. In addition, with the plug in the sealing spigot of EP 0 706 832 B1, setting of the correct ratio of the different openings in the compressed air distributor with respect to each other is exceedingly difficult, and a corresponding simulation or calculation is possible only at great expenditure. Here too, a linear adjustment kinematics is not possible, and the knurling knob changes its distance from the body. If it is in an undesirable high position, it is possible, under some circumstances, to introduce overspray into the gun, which is not the case in the solution according to the invention.

An additional advantage of the invention is that single-handed operation of the rotary distributor 14 is possible without a problem.

In an alternative design of the distribution spindle 13, the rotary distributor can also be designed differently. For example, as rotary distributor, a hollow cylinder can be used whose lateral surface halves, divided in the axial direction, present symmetric, mutually transitioning round jet, wide jet and compressed air feed line setting areas. As a result, the hollow cylinder could be turned with a rotation of 180° from the completely opened into the completely closed position of the wide jet line opening 7′, wherein, due to the subsequent further rotation in the same direction, the wide jet line opening 7′ could then be opened again in a corresponding manner. Instead of a division into halves, the hollow cylinder can also be divided into quarters, which again present corresponding symmetric and mutually transitioning round jet, wide jet, and compressed air feed line setting areas. Then, by means of a rotation of 90°, one can alternate between the opened and closed position of the wide jet line opening 7′, namely a total of four times within one full rotation of the hollow cylinder. Said alternatives present the advantage that no abutments are needed to prevent overrotation of the distributor spindle in any direction. If the round jet, wide jet, and compressed air feed line setting areas in the alternatives are mutually transitioning, but not mutually symmetrical in design, then different characteristics of the compressed air distribution could be enabled between the opened and closed position of the wide jet line opening.

In an additional alternative, instead of the rotary distributor 14, a solid cylinder can also be used, which presents an inlet opening that serves to partially open or close the compressed air feed line 10, wherein, from this inlet opening, two channels then branch off in the solid cylinder to the wide jet line opening 7′ or the round jet line opening 6′. The channels then present, at their other end, openings in the solid cylinder which are designed in such a manner in reference to the wide jet line opening 7′ or round jet line opening 6′, that, when the wide jet line opening 7′ is completely closed, the allowed maximum pressure still is applied on the round jet line opening 6′. Similarly, all the openings in the solid cylinder are designed in such a manner that, during the closing process, the maximum pressure is exceeded at no point at or in the round jet line 6 or the wide jet line 7.

In an additional embodiment, the round jet line opening 6′, the wide jet line opening 7′ or the compressed air feed line opening 10′ or also several of these openings can open at the bottom of the compressed air distribution cylinder 8. To be able to close or open said openings arranged in the bottom, the corresponding setting area then has to be provided with opening and closing areas in the bottom disk 16 of the distribution spindle 13. For example, if the wide jet line opening is in an eccentric position in the bottom of the compressed air distribution cylinder 8, that is outside of its central longitudinal axis, then it would be advantageous if, in the bottom disk 16, a wide jet line opening adapted to the size of the wide jet line opening would narrow in a spiral pattern to a wide jet closing area without opening.

In an additional embodiment, the compressed air distribution chamber can present, instead of a continuous compressed air distribution cylinder 8 with one diameter, preferably also mutually axially arranged cylinder bores of different diameter, where the diameter preferably decreases stepwise from the opening of the compressed air distribution chamber to the bottom. The distributor device is then advantageously adapted to the change in diameter. Instead of a step-shaped change in the diameter of the compressed air distribution chamber, the compressed air distribution chamber can also be designed advantageously in a conical shape or present a conical area, wherein the distributor device is then also adapted advantageously to this shape of the compressed air distribution chamber.

In order to make the advantages of the invention available for an already existing paint spray gun, the compressed air distribution insert can be formed from the distribution spindle 13 with the rotary distributor 14, the threading sheath 18, the knurled knob 15, and the threaded screw 19. Said compressed air distribution insert can then be inserted in the compressed air distribution chamber of the existing paint spray gun. Here, the shape of the compressed air distribution chamber can be taken into account advantageously in the design and modeling of the rotary distributor. Similarly, the other components of the compressed air distribution insert are adapted to the circumstances of the existing paint spray gun. Due to the simple design of the rotary distributor, the determination of its shape and the resulting compressed air distribution in the compressed air distribution chamber can be determined in a simple manner from the shape of the existing compressed air distribution chamber. The additional advantages and designs of the individual components of the compressed air distribution insert, which are indicated extensively above in the description of the pain spray gun according to the invention, naturally also apply to the compressed air distributor inset itself. Instead of the knurled knob, any other suitable rotating handle can be attached to the distribution spindle.

Other alternative embodiments, in which the mouths of the round jet line 6, of the wide jet line 7, as well as of the compressed air feed line 10 into the compressed air distribution cylinder 8 can be adjusted exclusively by turning about the axis of rotation D, without actual shift of rotary distributors, perforated aperture plates, etc., are also within the scope of the present invention.

List of references

| | |
|---|---|
| 1 | Paint spray gun |
| 2 | Handle |
| 3 | Paint nozzle head |
| 4 | Round jet nozzle |
| 5 | Wide jet nozzle |
| 6 | Round jet line |
| 6′ | Round jet line opening |
| 7 | Wide jet line |
| 7′ | Wide jet line opening |
| 8 | Compressed air distribution cylinder |
| 8a | Bottom |
| 8b | Lateral surface |
| 8c | Opening |
| 9 | Compressed air distributor |
| 10 | Compressed air feed line |
| 10′ | Compressed air feed line opening |
| 11 | Valve device |
| 11a | Draw-off |
| 12 | Compressed air feed |
| 13 | Distribution spindle |
| 14 | Rotary distributor |
| 15 | Knurling knob |
| 16 | Bottom disk |
| 17 | Cover plate |
| 18 | Threaded sleeve |
| 19 | Threaded screw |
| 20 | Setting display |
| 21 | Abutment |
| 22 | Distance |
| 23 | Gasket seal |
| 24 | Collar |
| 25 | Upper area of 14 |
| 26 | Lower area of 14 |
| 27 | Threading |
| 28 | Position marking |
| 29 | Middle area |
| 30 | Marking |
| 146 | Wide jet setting area |
| 146a | Wide jet closing area |
| 146b | Wide jet opening area |
| 147 | Round jet setting area |
| 147a | Round jet setting opening |
| 148 | Short area |

1-21. (canceled)

22. In a paint spray gun with a compressed air distribution chamber, into which opens a compressed air feed line, a round jet line, and a wide jet line, wherein compressed air fed to the compressed air distribution chamber is distributed from the compressed air feed line to the round jet line and the wide jet line via a setting member positioned in the compressed air distribution chamber, the setting member being rotatable via an external actuation element about an axis of rotation extending through the compressed air distribution chamber, the improvement comprising the setting member being mounted in the compressed air distribution chamber solely for rotational movement and constrained in the axial direction, the setting member being designed for opening and closing communication between the compressed air feed line, a round jet line, and a wide jet line.

23. In a paint spray gun according to claim 22, wherein the compressed air distribution chamber is cylindrical, open at one end and closed at its other end and bounded by a lateral surface.

24. In a paint spray gun according to claim 23, wherein the setting member is an elongated rotary distributor having on one end a rotary handle and a guide on its other end.

25. In a paint spray gun according to claim 24, wherein the guide is a circular and one of a disk and a circular ring, said guide having an outer diameter equal to the inner diameter of the compressed air distribution cylinder.

26. In a paint spray gun according to claim 24, wherein the rotary distributor is formed as a section of a cylinder about the axis of rotation.

27. In a paint spray gun according to claim 24, wherein the rotary distributor has a wide jet setting portion for controlling communication between the compressed air distribution chamber and the wide jet line.

28. In a paint spray gun according to claim 27, wherein the wide jet setting portion enables one of an exponential, linear or digressive control.

29. In a paint spray gun according to claim 24, wherein the rotary distributor has a round jet setting portion for controlling communication between the compressed air distribution chamber and the round jet line.

30. In a paint spray gun according to claim 24 wherein the rotary distributor has a compressed air feed portion for controlling communication with the compressed air feed line.

31. In a paint spray gun according to claim 23 wherein the round jet line, the wide jet line, and the compressed air feed line open into the air distribution chamber at the lateral surface.

32. In a paint spray gun (1) according to claim 24 wherein at least one setting display is provided for displaying the setting of the rotary distributor in the compressed air distribution chamber.

33. In a paint spray gun according to claim 32, wherein the setting display is provided on the external actuation element.

34. In a paint spray gun according to claim 32 wherein the at least one setting display is in the form of a raised position marking.

35. In a paint spray gun according to claim 22 wherein the actuation element has at least one abutment that coacts with at least one abutment on the paint spray gun to limit rotation of the setting member.

36. In a paint spray gun according to claim 35, wherein the coacting abutments determine at least extreme opening and closing positions.

37. In a paint spray gun according to claim 36, wherein between the opening and closing positions, the setting member can rotate an angle of approximately 95°.

38. Compressed air distributor inset for a paint spray gun comprising a distribution spindle for inserting into a compressed air distribution chamber formed in the paint spray gun and being held rotatably therein about an axis of rotation by a threaded sleeve that can be screwed into a threaded opening in the paint spray gun; an actuation element mounted on one end of the distribution spindle for providing rotary actuation of the distribution spindle; a rotary distributor fixed on the other end of the distribution spindle such that when the compressed air distributor inset is inserted into the compressed air distribution chamber it can be moved solely rotationally and not axially.

39. Compressed air distribution insert according to claim 38, wherein the compressed air distributor consists of a first portion composed of a material different from that of a second portion.

40. Compressed air distribution insert according to claim 38, characterized in that the distribution spindle is made of metal, and the rotary distributor is made of plastic.

41. Compressed air distribution insert according to claim 40, wherein said first portion is made of brass and said second portion is made of polyamide.
